(19) United States
(12) Patent Application Publication
(10) Pub. No.: US 2026/0065172 A1
(43) Pub. Date: Mar. 5, 2026

(54) ARTIFICIAL INTELLIGENCE QUERY RESPONSE SYSTEM WITH ANOMALY DETECTION

(71) Applicant: Dell Products L.P., Round Rock, TX (US)

(72) Inventors: Bijan Kumar Mohanty, Austin, TX (US); Shamik Kacker, Austin, TX (US); Hung T. Dinh, Austin, TX (US)

(21) Appl. No.: 18/819,307

(22) Filed: Aug. 29, 2024

(51) Int. Cl. G06N 20/20

(52) U.S. Cl. CPC G06N 20/20

(57) ABSTRACT

Methods, apparatus, and processor-readable storage media for artificial intelligence query response systems with anomaly detection are provided herein. An example computer-implemented method includes obtaining at least one user query; performing a comparison of the at least one user query to one or more previous user queries contained within at least portions of one or more data structures; performing, based on results of the comparison, anomaly detection analysis on the at least one user query by processing the at least one user query against the one or more previous user queries contained within the at least portions of the data structure(s) using one or more anomaly detection algorithms; and generating, based on results of the anomaly detection analysis, at least one response to the at least one user query by processing, using an artificial intelligence system, the at least one user query and context information related thereto.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Some artificial intelligence techniques are trained to answer various user questions. However, conventional artificial intelligence-based question-answer techniques commonly fail to analyze user questions for context and/or compliance with one or more designated parameters, resulting in responses that are error-prone and/or leading to resource-intensive additional iterations of communication.

### SUMMARY

Illustrative embodiments of the disclosure provide artificial intelligence query response systems with anomaly detection.

An exemplary computer-implemented method includes obtaining at least one user query, and performing a comparison of the at least one user query to one or more previous user queries contained within at least portions of one or more data structures. Also, the method includes performing, based at least in part on results of the comparison, anomaly detection analysis on the at least one user query by processing the at least one user query against the one or more previous user queries contained within the at least portions of the one or more data structures using one or more anomaly detection algorithms. Further, the method additionally includes generating, based at least in part on results of the anomaly detection analysis, at least one response to the at least one user query by processing, using an artificial intelligence system, the at least one user query and context information related to the at least one user query.

Illustrative embodiments can provide significant advantages relative to conventional artificial intelligence-based question-answer techniques. For example, problems associated with errors and/or resource-intensive additional iterations of communication are overcome in one or more embodiments through implementing a security-enhanced artificial intelligence query response system with machine learning-based processing of data structures for anomaly detection. These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing an artificial intelligence query response system with machine learning-based processing of data structures in an illustrative embodiment.

FIG. 2 shows example architecture for a retrieval augmented generation (RAG) system in an illustrative embodiment.

FIG. 3 shows example pseudocode for implementing at least a portion of a large language model (LLM) interface workflow in an illustrative embodiment.

FIG. 4 shows example pseudocode for implementing at least a portion of an LLM request caching engine in an illustrative embodiment.

FIG. 5 shows example pseudocode for determining cached questions similar to an input question in an illustrative embodiment.

FIG. 6 shows example graph implementations of an isolation forest algorithm in an illustrative embodiment.

FIG. 7 shows example pseudocode for performing anomaly detection in an illustrative embodiment.

FIG. 8 is a flow diagram of a process for implementing an artificial intelligence query response system with machine learning-based processing of data structures in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

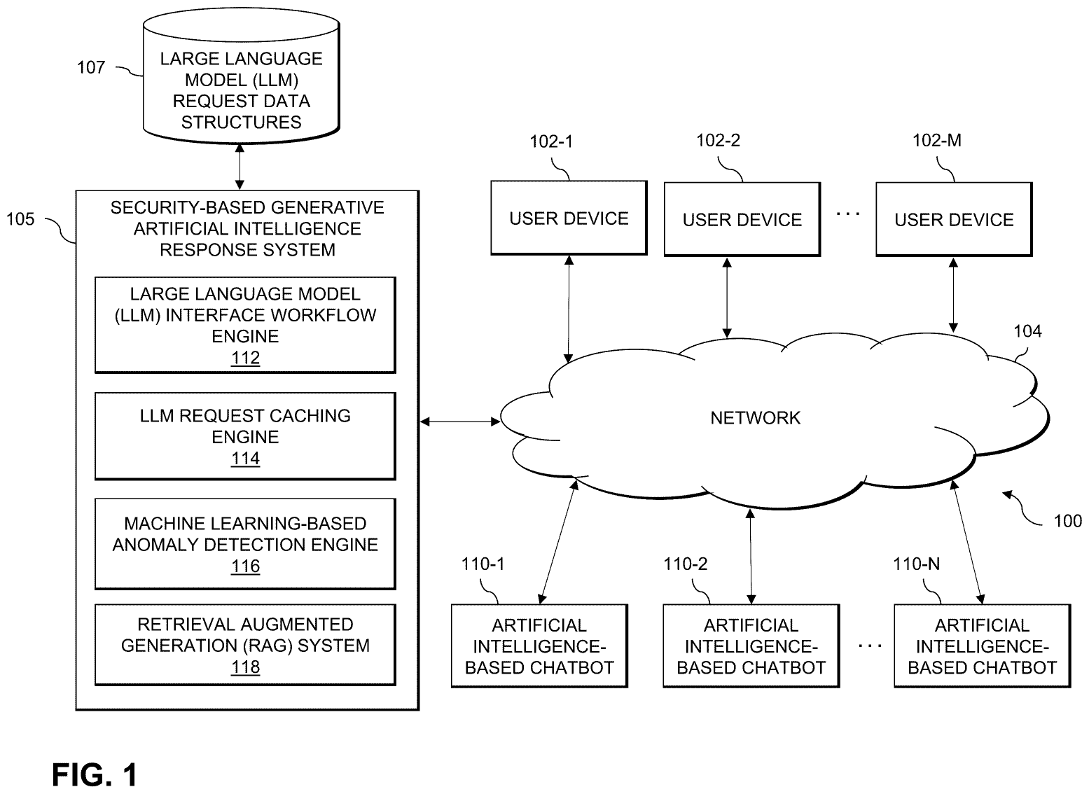

FIG. 1 shows a computer network (also referred to herein as an information processing system) 100 configured in accordance with an illustrative embodiment. The computer network 100 comprises a plurality of user devices 102-1, 102-2, 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is security-based generative artificial intelligence response system 105, and a plurality of artificial intelligence-based chatbots 110-1, 110-2, 110-N, collectively referred to herein as artificial intelligence-based chatbots 110. The artificial intelligence-based chatbots 110 can include, for example, generative artificial intelligence chatbots which can be accessed by and/or resident on user devices 102.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the security-based generative artificial intelligence response system 105 can have one or more associated LLM request data structures 107 configured to store data pertaining to historical queries, input queries, query token count data, query similarity score data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The LLM request data structures 107 in the present embodiment are implemented using one or more storage systems associated with the security-based generative artificial intelligence response system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the security-based generative artificial intelligence response system 105 are one or more input-output devices, which illustratively comprise keyboards, displays or other types of input-output devices in any combination. Such input-output devices can be used, for example, to support one or more user interfaces to the security-based generative artificial intelligence response system 105, as well as to support communication between the security-based generative artificial intelligence response system 105 and other related systems and devices not explicitly shown.

Additionally, the security-based generative artificial intelligence response system 105 in the FIG. 1 embodiment is assumed to be implemented using at least one processing device. Each such processing device generally comprises at least one processor and an associated memory, and implements one or more functional modules for controlling certain features of the security-based generative artificial intelligence response system 105.

More particularly, the security-based generative artificial intelligence response system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the security-based generative artificial intelligence response system 105 to communicate over the network 104 with the user devices 102, and illustratively comprises one or more conventional transceivers.

The security-based generative artificial intelligence response system 105 further comprises an LLM interface workflow engine 112, LLM request caching engine 114, machine learning-based anomaly detection engine 116, and RAG system 118.

It is to be appreciated that this particular arrangement of elements 112, 114, 116 and 118 illustrated in the security-based generative artificial intelligence response system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for implementing a security-enhanced artificial intelligence query response system with machine learning-based processing of data structures for anomaly detection involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of security-based generative artificial intelligence response system 105, LLM request data structures 107, and artificial intelligence-based chatbots 110 can be on and/or part of the same processing platform.

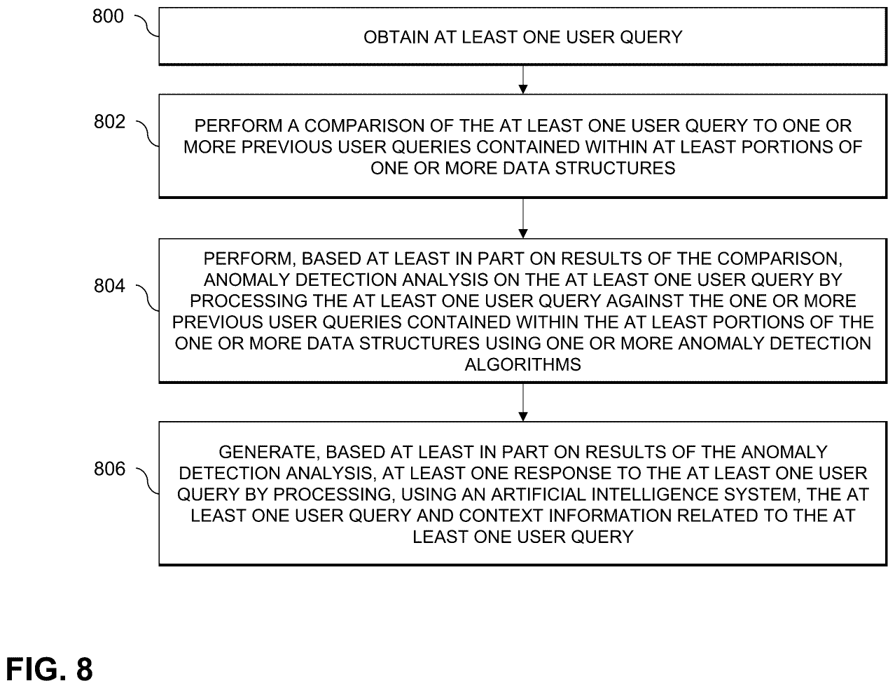

An exemplary process utilizing elements 112, 114, 116 and 118 of an example security-based generative artificial intelligence response system 105 in computer network 100 will be described in more detail with reference to the flow diagram of FIG. 8.

Accordingly, at least one embodiment includes implementing role-based access control and domain-specific security in connection with artificial intelligence-based question-answer systems by enhancing prompt security and relevance using RAG techniques. As detailed herein, RAG architecture, which combines the benefits of neural retrieval with at least one transformer-based generative model, enables the generation of rich, informed query responses that are directly conditioned by data retrieved in approximately real-time. Such architecture is useful, for example, in scenarios wherein responses require domain-specific knowledge that is current and accurate (e.g., such as in customer service chatbots, smart assistants or co-pilots for knowledge workers, real-time decision support systems, etc.).

Using RAG techniques, a prompt not only directs the focus of a retrieval component but also shapes a subsequent generation process. A well-designed prompt ensures that the retrieval system focuses on relevant documents and/or data snippets, which significantly influences the quality and relevance of the artificial intelligence-generated content. As such, prompt engineering is important in enhancing the performance of RAG models, enabling outputs to not only be contextually accurate but also aligned with one or more specific needs and/or compliance standards of the user and/or enterprise associated with the artificial intelligence-based question-answer system. Accordingly, one or more embodiments include implementing monitoring and filtering mechanisms on top of RAG techniques within LLM frameworks in artificial intelligence-based question-answer systems.

As further detailed herein, at least one embodiment includes leveraging one or more machine learning-based techniques to detect inappropriateness in user prompts and/or questions based at least in part on the domain and role of the user. Additionally, such an embodiment can include using machine learning-based anomaly detection techniques to detect anomalous and/or malicious activities (e.g., jailbreaking) and trigger any correspondingly necessary monitoring.

One or more embodiments include implementing a multi-prong approach to validate user prompts and/or questions by leveraging machine learning algorithms to determine if the prompts and/or questions are similar to past prompts and/or questions from users in similar domain contexts and/or roles as the currently submitting user(s). Additionally, such an embodiment can include using anomaly detection techniques to identify malicious prompts and/or questions by learning and/or determining prompt and/or question patterns of the submitting user(s) and raising anomaly alerts upon such detection.

Referring again to FIG. 1, at least one embodiment includes obtaining and/or intercepting a user prompt and/or question (after submission via at least one of user devices 102) and verifying if the prompt and/or question has already been submitted by searching the LLM request data structures 107 and retrieving a matching response if identified. If the prompt and/or question is determined to be sufficiently different from the historical prompts and/or questions submitted by similar users (e.g., users with the same or similar role within an enterprise), one or more embodiments can include detecting this as a violation of prompt and/or question appropriateness and replying with a generic message and/or alert for remediation. By way merely of example, in an enterprise setting, the types of questions and/or prompts provided by users are often scoped based largely on the role(s) of the users. A conventional LLM might allow all types of questions and/or prompts, while one or more embodiments can include configuring parameters such that context-specific appropriate questions and/or prompts are allowed and processed.

In at least one embodiment, RAG techniques are used to leverage a vector database (e.g., at least a portion of LLM request data structures 107) and semantic search the database to enhance the capabilities of an LLM with specific domain context.

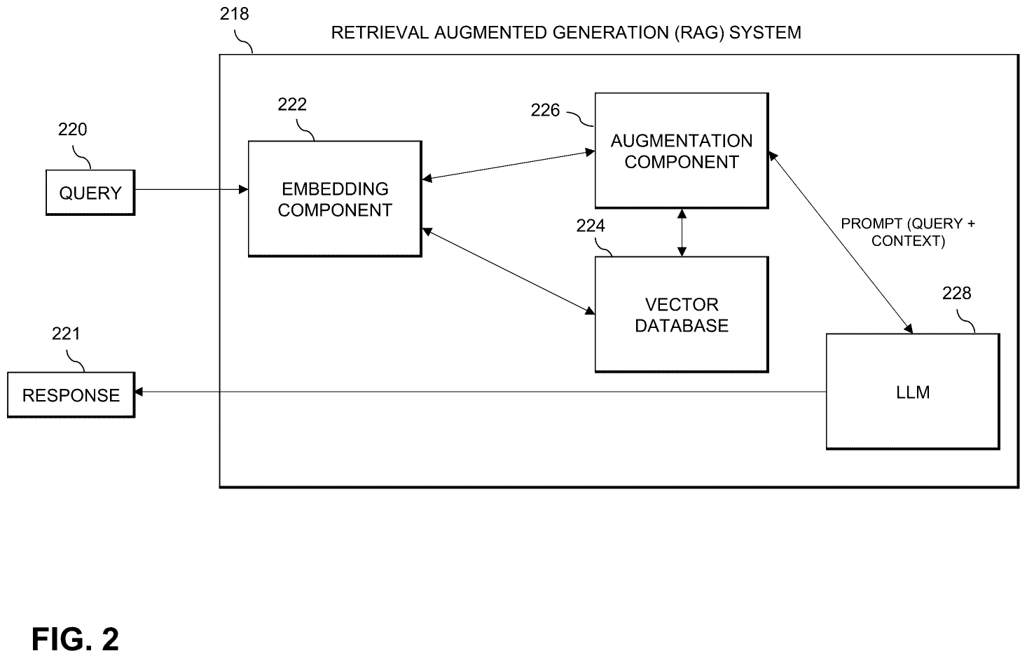

FIG. 2 shows example architecture for RAG system 218 in an illustrative embodiment. By way of illustration, FIG. 2 depicts RAG system 218 processing query 220 to generate response 221. More particularly, such processing by RAG system 218 includes the use of embedding component 222, vector database 224, augmentation component 226, and LLM 228.

For example, in connection with embedding component 222, embedding the query 220 includes transforming the query 220 into an embedding, which can include a high-dimensional vector (i.e., number) representation, using a neural network encoder (e.g., bidirectional encoder representations from transformers (BERT)). This encoding is required, for example, to convert text data into numerical data, while accurately capturing the semantic essence of the query 220, thus representing the query's intent and/or meaning.

Once the query 220 is encoded, the corresponding vector is used to perform a semantic search in vector database 224 to return at least one domain context pertinent to the query 220. In one or more embodiments, the vector database 224 is pre-populated with pre-encoded vectors representing an array of domain-specific information, which can be used to find the relevant context for a given query. The semantic search leverages the similarities in the vector space, identifying the database entries and/or records having embeddings which most closely align with that of the query 220.

With the relevant context for the query 220 retrieved, at least one embodiment then includes integrating, using augmentation component 226, at least a portion of the retrieved context information into a prompt for the LLM 228. This prompt includes the original query 220 and the at least a portion of retrieved domain-specific information to maintain logical and semantic continuity. Further, the constructed prompt is fed to LLM 228 to generate and output response 221, which is not only relevant and accurate to the query 220, but also enriched with domain-specific knowledge.

In conventional RAG systems, each individual query must go through the RAG process of encoding/vectorization, semantic search and LLM request processing to return a response, which leads to unnecessary costs and/or overhead in cases wherein the same or similar questions have previously been asked. Additionally, such conventional RAG systems typically provide no validation in terms of shots and/or token size, which can pose security risks, e.g., in terms of answering inappropriate questions by leveraging jail-breaking techniques.

Such concerns and/or disadvantages are addressed in one or more embodiments by implementing components (e.g., LLM interface workflow engine 112, LLM request caching engine 114, and machine learning-based anomaly detection engine in the example FIG. 1 embodiment) in connection with a RAG architecture that can intercept a request and apply filtering and anomaly detection techniques to reduce unnecessary overhead as well as detect inappropriate queries and/or abnormal activities.

In such an embodiment, queries are passed through an LLM interface workflow engine, which can generate a common word embedding vector of each query. This can be carried out, for example, using an embedding method such as term frequency-inverse document frequency (TF-IDF), latent semantic analysis (LSA), GloVe, Word2Vec, etc. Once a given vector is generated, a hash of the vector is created to be used as the unique identifier in the cache (e.g., at least a portion of LLM request data structures 107). This hash will be used to query the cache to determine if the given query was previously processed, and if so, to retrieve the previous corresponding response from the cache. Such an embodiment can include precluding the expense of processing through the RAG architecture and LLM again for a query that has already been asked and processed. If the request vector hash is not found in the cache, the LLM interface workflow engine calculates similarity scores for previously processed queries (e.g., previous queries asked by similar users and/or users in similar roles as the user submitting the new/input query), in relation to the new/input query.

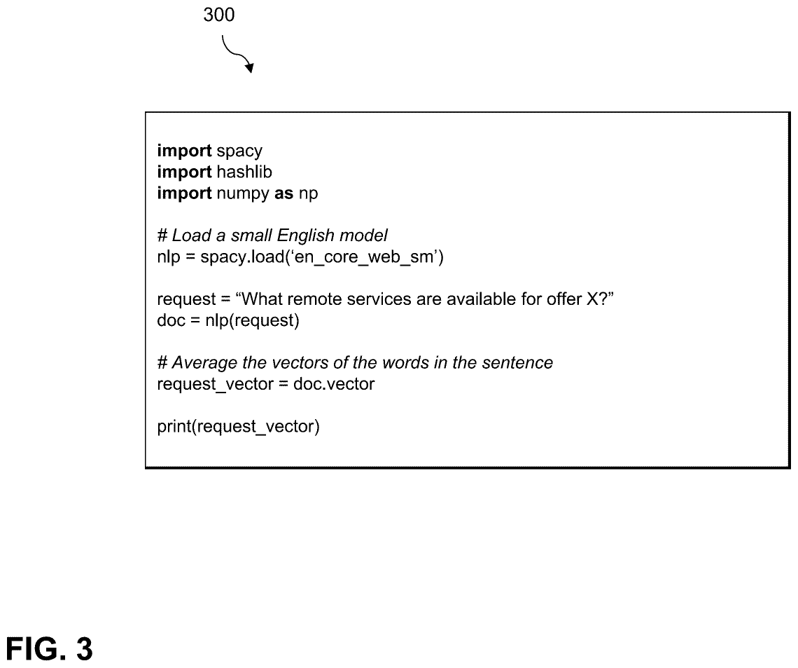

FIG. 3 shows example pseudocode for implementing at least a portion of an LLM interface workflow engine in an illustrative embodiment. In this embodiment, example pseudocode 300 is executed by or under the control of at least one processing system and/or device. For example, the example pseudocode 300 may be viewed as comprising a portion of a software implementation of at least part of security-based generative artificial intelligence response system 105 of the FIG. 1 embodiment.

The example pseudocode 300 illustrates creating a vector of a request sentence, which includes importing and using a natural language processing (NLP) library (e.g., Spacy) to generate the vector for the request sentence. Purposes of vectorization include creating an identifier of the request and using the identifier as a feature in a prediction engine for predicting the most appropriate vector store and LLM. As also depicted in FIG. 3, example pseudocode 300 illustrates averaging the vectors of the words in the request sentence, and printing and/or outputting final (e.g., averaged) vector.

It is to be appreciated that this particular example pseudocode shows just one example implementation of at least a portion of an LLM interface workflow, and alternative implementations can be used in other embodiments.

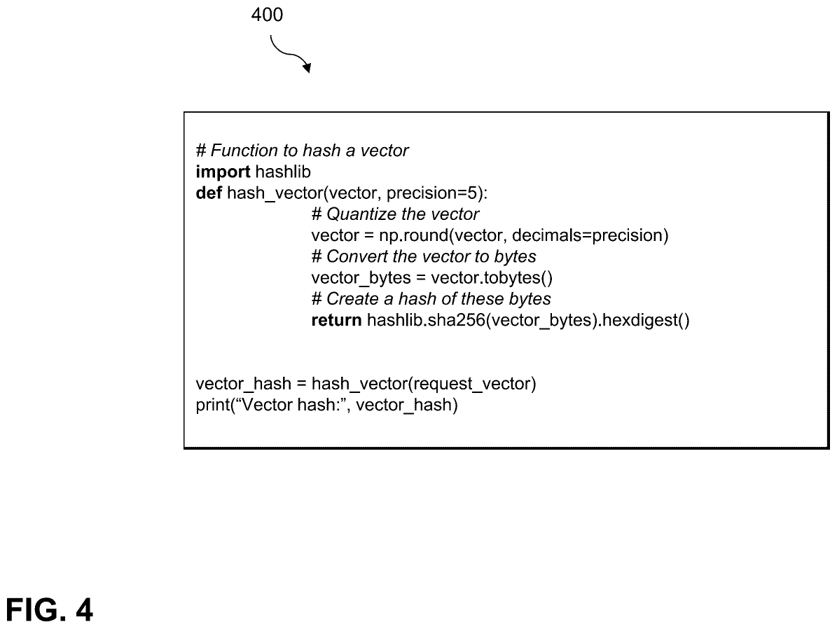

FIG. 4 shows example pseudocode for implementing at least a portion of an LLM request caching engine in an illustrative embodiment. In this embodiment, example pseudocode 400 is executed by or under the control of at least one processing system and/or device. For example, the example pseudocode 400 may be viewed as comprising a portion of a software implementation of at least part of security-based generative artificial intelligence response system 105 of the FIG. 1 embodiment.

The example pseudocode 400 illustrates generating a hash from a request vector (such as, for example, depicted in connection with FIG. 3). As further detailed herein, an LLM request caching engine is responsible for caching a request to and corresponding response by a given LLM in connection with one or more generative artificial intelligence initiatives. More particularly, after generating a vector of the request (as seen, e.g., in FIG. 3), the vector is hashed to create a unique identifier for querying the caching engine to check and/or determine if the same request was processed previously. If the unique identifier is found in the cache, the corresponding response can be retrieved from the cache and returned, thus eliminating the need to process the complete RAG transaction, which can improve the performance and reduce the cost of the LLM. As illustrated in example pseudocode 400, generating a hash from a request vector includes importing a hashing function, quantizing the vector, converting the vector to bytes, and creating a hash of at least a portion of the bytes. Example pseudocode 400 also illustrates printing and/or outputting the vector hash.

It is to be appreciated that this particular example pseudocode shows just one example implementation of at least a portion of an LLM request caching engine, and alternative implementations can be used in other embodiments.

In one or more embodiments, data to be cached in LLM request caching engine can include, e.g., the hash created of the vector of the request, search domain identifying information (e.g., user, role, program and/or chatbot identifier (ID)), the entire vector of the request as generated from vectorization, the token size of the request, and the response from the LLM.

If a search of the cache based on a request_hash turns up no matches, indicating that the question is being asked for the first time, the LLM request caching engine returns one or more previously asked questions form the cache using domain search criteria which can return a list of questions. Similarity search algorithms such as, e.g., cosine similarity, Euclidian distance, etc., can be applied on cache data along with the current question being asked to return similarity scores. These scores, along with the token count, are then passed to another component to detect if the new question being asked is similar to the questions asked by other domain users or if the new question is an anomaly.

With respect to the token count, any prompt to a LLM can be broken into tokens during encoding, and relevant token count rules are applied to each LLM. By way merely of example, tokens can represent words in the prompt and/or other characters such as commas, etc. Also, LLMs can often support different token count limits. At least one embodiment includes implementing token count anomaly detection to detect and alert abnormal behavior in terms of questioning (e.g., some LLMs can support high token counts and bad actors can attempt to exploit the LLMs using jailbreaking techniques). For instance, if a user typically sends between 2,000 and 6,000 tokens in prompts and/or questions, the user sending 40,000 tokens in a prompt and/or question might be detected as abnormal.

By way merely of example, in connection with text analysis, one or more embodiments can include using cosine similarity to compare the orientation of two text documents as vectors in a multi-dimensional space. By calculating the cosine of the angle between these two vectors, such an embodiment can include deriving a similarity score (e.g., a score ranging from −1 to 1, wherein 1 indicates that the vectors are perfectly aligned (indicating identical direction and maximum similarity), 0 indicates orthogonality (i.e., no similarity), and −1 represents completely opposite directions). In such an embodiment, a score closer to 1 indicates a high degree of similarity and a score closer to 0 indicates dissimilarity.

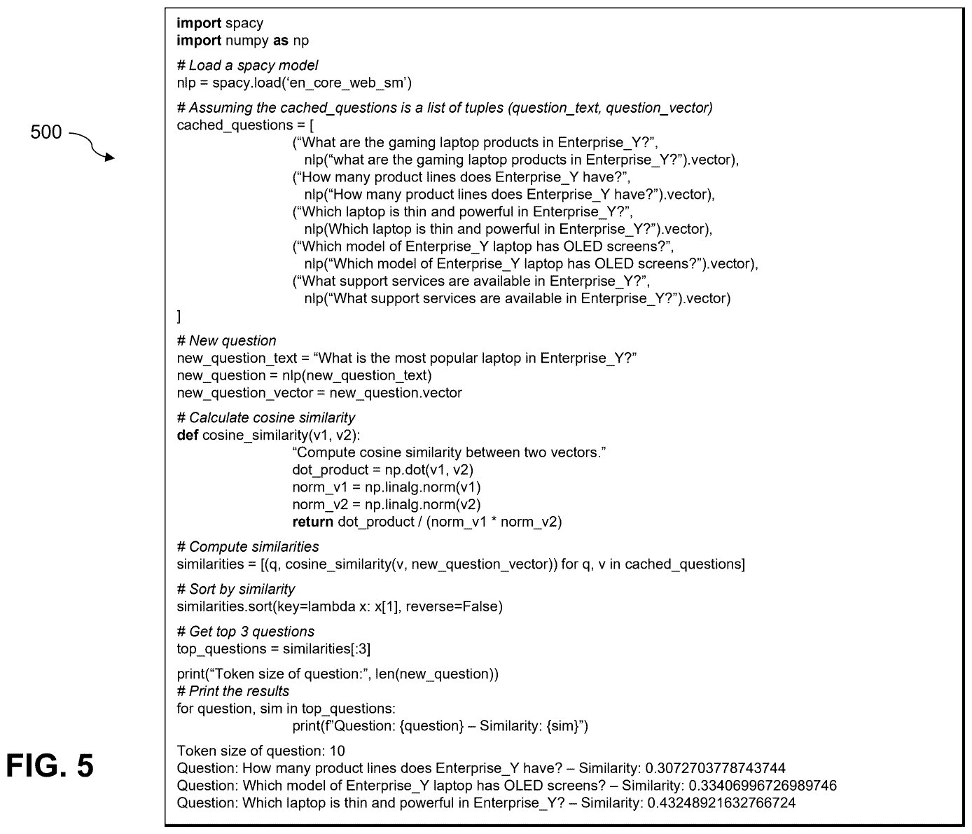

FIG. 5 shows example pseudocode for determining cached questions similar to an input question in an illustrative embodiment. In this embodiment, example pseudocode 500 is executed by or under the control of at least one processing system and/or device. For example, the example pseudocode 500 may be viewed as comprising a portion of a software implementation of at least part of security-based generative artificial intelligence response system 105 of the FIG. 1 embodiment.

The example pseudocode 500 illustrates importing analysis and NLP libraries, loading an NLP model, and assuming that the relevant cached questions comprise a list of tuples. In the example embodiment detailed in example pseudocode 500, five questions were vectorized and cached as a list of tuples in Python, and the new (input) question is also vectorized. Additionally, the total token count size and similarity scores (calculated using cosine similarity) are calculated for the new question with respect to the cached questions. The cached questions with the three lowest similarity scores are returned, as illustrated in example pseudocode 500.

Although the brute-force approach of using all cached questions is used in a loop for the simplicity to convey the functionality in FIG. 5, other implementations in one or more embodiments can include using a nearest distance indexing approach using a similarity score library. As illustrated in example pseudocode 500, the lowest three scores (in the reverse order) are returned to display the distance from the most dissimilar questions to determine if the new question is different. A lower score (e.g., closer to 0) indicates that the new question is dissimilar from the given cached question. Once these scores are computed, the scores and/or corresponding cached questions can be processed for anomaly detection, as further detailed herein.

It is to be appreciated that this particular example pseudocode shows just one example implementation of determining cached questions similar to an input question, and alternative implementations can be used in other embodiments.

As detailed herein, one or more embodiments include implementing an anomaly detection engine, which determines if the new question being asked is a typical and/or regular question asked by users of the same domain (as the user asking the new question) or if the new question being asked is an anomalous question based on similarity scores and at least one threshold value. Additionally, the anomaly detection engine can leverage at least one machine learning algorithm that utilizes unsupervised learning to detect anomalies. At least one embodiment includes leveraging at least one isolation forest algorithm in the anomaly detection engine.

Anomaly detection can include identifying a situation that is not considered typical and/or normal based at least in part on past observations of the one or more properties being considered. In one or more embodiments, historical request transactions can have a similarity score, and anytime a similarity score of a new question deviates dramatically from historic similarity scores, the anomaly detection mechanism can identify the new question as an outlier.

In such an embodiment, detecting anomalies includes implementing supervised learning using support vector machine (SVM) and/or at least one artificial neural network (ANN). Such an embodiment includes using labeled data to indicate which element represents typical conditions and which elements can represent anomalous conditions. Additionally or alternatively, performing anomaly detection can include implementing unsupervised learning mechanisms using shallow and/or deep learning. For example, multivariate anomaly detection can be implemented using at least one isolation forest algorithm, which does not need labeled training data. An isolation forest algorithm can be effective in dealing with swamping and masking effects. A masking effect can arise wherein a model predicts a normal behavior of a microservice when the behavior is anomalous. Similarly, a swamping effect can arise wherein a model predicts an anomalous behavior when the behavior represents a normal microservice transaction. Additionally, isolation forest algorithms can include using at least one decision tree ensemble method with an assumption that anomalies can be isolated with one or more conditions. For example, such an algorithm can identify anomalies among normal observations by setting at least one threshold value in a contamination parameter that can be applied for real time prediction. As used herein, a contamination parameter in an anomaly detection algorithm controls the threshold of the decision function. For example, the decision can be whether a given point is considered normal behavior or anomalous behavior. For example, if a given token count threshold is 30,000 tokens, any count less than 30,000 would be considered normal and any token count above 30,000 would be considered anomalous.

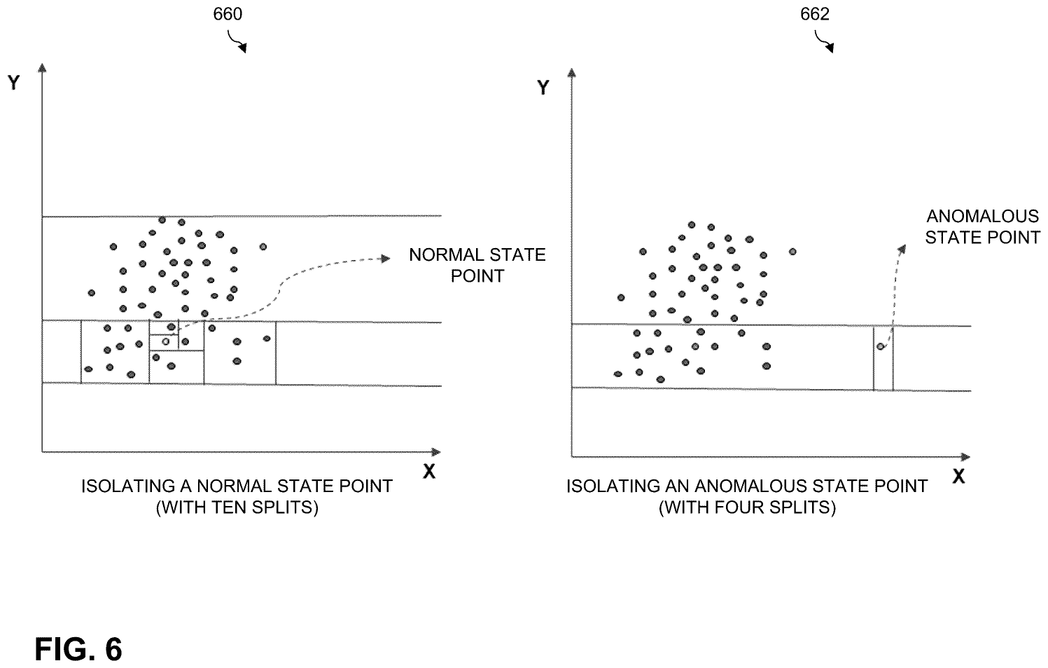

FIG. 6 shows example graph implementations of an isolation forest algorithm in an illustrative embodiment. By way of illustration, FIG. 6 depicts graph 660, which displays isolating a normal state point using ten splits, and graph 662, which displays isolating an anomalous state point using four splits. The X-axis and Y-axis of isolation forest algorithm graphs such as graph 660 and 662 can be associated with various values which can be context-specific from use case to use case. In at least one embodiment, within the context of token count anomaly detection, one axis can represent actual token count, and the other axis can represent domain(s) and/or role(s) of the user(s).

Also, as illustrated and further detailed herein, isolation forest algorithms can isolate at least one anomaly by creating decision trees over random attributes. Such random partitioning produces shorter paths because fewer instances of anomalies result in smaller partitions, and distinguishable attribute values are more likely to be separated in early partitioning.

Accordingly, when a forest (i.e., a group) of random trees collectively produces shorter path lengths for some particular points, then such points are likely to be anomalies. In one or more embodiments, a larger number of splits can be required to isolate a normal state point (such as depicted, e.g., in graph 660), while an anomaly state point (or, simply, an anomaly) can be isolated using a smaller number of splits (such as depicted, e.g., in graph 662).

The number of splits, depicted in graph 660 and graph 662 via the horizontal and vertical lines within the graphs, determine the level at which the isolation occurred and can be used to generate the corresponding anomaly score. Anomaly scores can be calculated, for example, based at least in part on the contamination parameter threshold value. In one or more embodiments, an anomaly score can include a categorization or a classification assigned to each point (e.g., an anomaly point can have a score of −1 and a normal point can have a score of 1). In at least one embodiment, such a process can be repeated multiple times, and the isolation level of each point can be noted with each iteration. Once a given iteration is completed, the anomaly score of each point suggests the likeliness of an anomaly. In such an embodiment, the anomaly score can be a function of the average level at which the point is isolated, and one or more points (e.g., the top k points) are identified on the basis of the scores and labeled as anomalies.

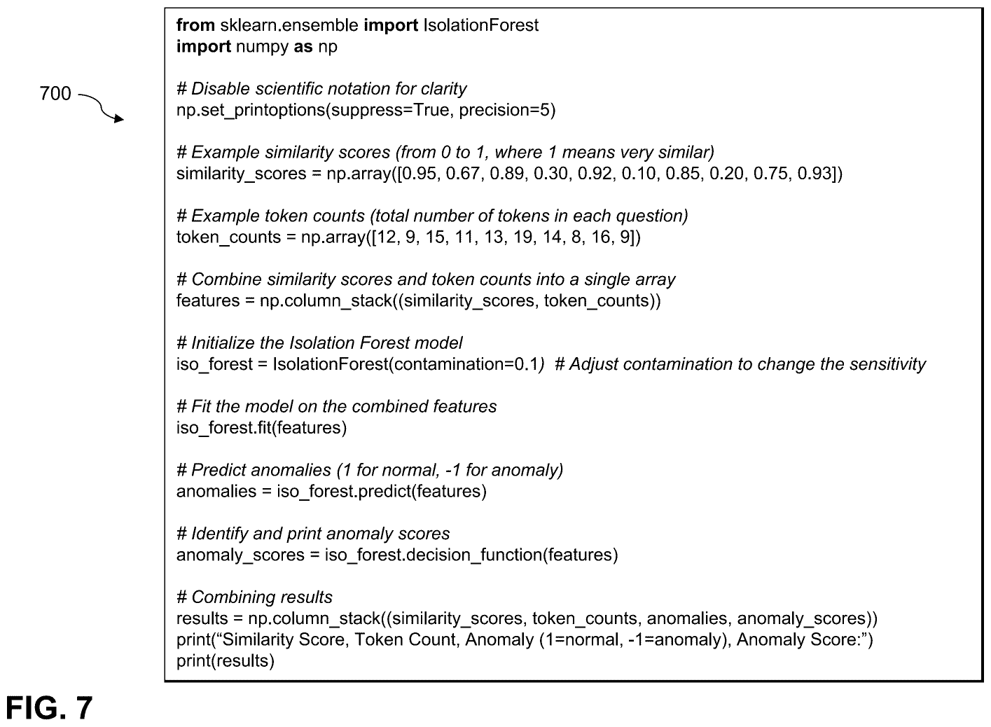

FIG. 7 shows example pseudocode for performing anomaly detection in an illustrative embodiment. In this embodiment, example pseudocode 700 is executed by or under the control of at least one processing system and/or device. For example, the example pseudocode 700 may be viewed as comprising a portion of a software implementation of at least part of security-based generative artificial intelligence response system 105 of the FIG. 1 embodiment.

The example pseudocode 700 illustrates importing an isolation forest function and one or more libraries. Additionally, example pseudocode 700 illustrates disabling one or more scientific notations, producing example similarity scores and token counts, combining the similarity scores and token counts into a single array, initializing the isolation forest model, fitting the model on the combined similarity score-token count features, predicting one or more anomalies, determining and printing related anomaly scores, and combining results (e.g., to display the values in one line) across the similarity scores, token counts, predicted anomalies, and anomaly scores.

In connection with FIG. 7, one or more embodiments include leveraging at least one multi-variate anomaly detection technique wherein, for example, two variables (e.g., similarity score and token count) are used to determine if a new/input question is normal to typical questions asked or if the new/input question is an anomaly. For example, such an embodiment can include using an array with cosine similarity scores between the new/input question and a given number (e.g., ten) of previous questions. Similarly, another array can contain the token counts of all of the given questions, and both arrays of vectors can be combined and used to train an isolation forest model, which can then be used to predict the normal/anomaly status of each data point.

It is to be appreciated that this particular example pseudocode shows just one example implementation of performing anomaly detection, and alternative implementations can be used in other embodiments.

FIG. 8 is a flow diagram of a process for implementing an artificial intelligence query response system with machine learning-based processing of data structures in an illustrative embodiment. It is to be understood that this particular process is only an example, and additional or alternative processes can be carried out in other embodiments.

In this embodiment, the process includes steps 800 through 806. These steps are assumed to be performed by the security-based generative artificial intelligence response system 105 utilizing elements 112, 114, 116 and 118.

Step 800 includes obtaining at least one user query. In at least one embodiment, obtaining at least one user query includes classifying the at least one user query based at least in part on one or more of user role and user-related domain.

Step 802 includes performing a comparison of the at least one user query to one or more previous user queries contained within at least portions of one or more data structures. In one or more embodiments, performing a comparison includes transforming the at least one user query into at least one embedding by processing the at least one user query using at least one neural network encoder, and using the at least one embedding to perform a semantic search of at least one vector database within the at least portions of the one or more data structures. Additionally or alternatively, performing a comparison can include processing the at least one user query and the one or more previous user queries contained within the at least portions of the one or more data structures using one or more similarity search algorithms.

Step 804 includes performing, based at least in part on results of the comparison, anomaly detection analysis on the at least one user query by processing the at least one user query against the one or more previous user queries contained within the at least portions of the one or more data structures using one or more anomaly detection algorithms. In at least one embodiment, performing anomaly detection analysis includes processing the at least one user query against the one or more previous user queries contained within the at least portions of the one or more data structures using at least one isolation forest algorithm. In such an embodiment, processing the at least one user query against the one or more previous user queries contained within the at least portions of the one or more data structures using at least one isolation forest algorithm can include isolating at least one non-anomalous state point, from the at least portions of the one or more data structures, using at least a first number of splits, and isolating at least one anomalous state point, from the at least portions of the one or more data structures, using at least a second number of splits. Additionally or alternatively, performing anomaly detection analysis can include processing the at least one user query against the one or more previous user queries contained within the at least portions of the one or more data structures using one or more of at least one SVM algorithm and at least one ANN.

Step 806 includes generating, based at least in part on results of the anomaly detection analysis, at least one response to the at least one user query by processing, using an artificial intelligence system, the at least one user query and context information related to the at least one user query. In one or more embodiments, generating at least one response to the at least one user query includes processing the at least one user query and context information related to the at least one user query using an RAG system. Additionally or alternatively, generating at least one response to the at least one user query can include generating the at least one response upon a determination that (i) the at least one user query is below a designated similarity level relative to the one or more previous user queries, and (ii) the at least one user query is below a designated anomaly detection level relative to the one or more previous user queries.

In at least one embodiment, the techniques depicted in FIG. 8 can also include automatically outputting the at least one response to one or more systems associated with the at least one user query. Further, such an embodiment can include automatically training at least a portion of the one or more anomaly detection algorithms based at least in part on feedback related to the at least one response to the at least one user query.

Accordingly, the particular processing operations and other functionality described in conjunction with the flow diagram of FIG. 8 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to implement a security-enhanced artificial intelligence query response system with machine learning-based processing of data structures for anomaly detection. These and other embodiments can effectively overcome problems associated with errors and/or resource-intensive additional iterations of communication.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

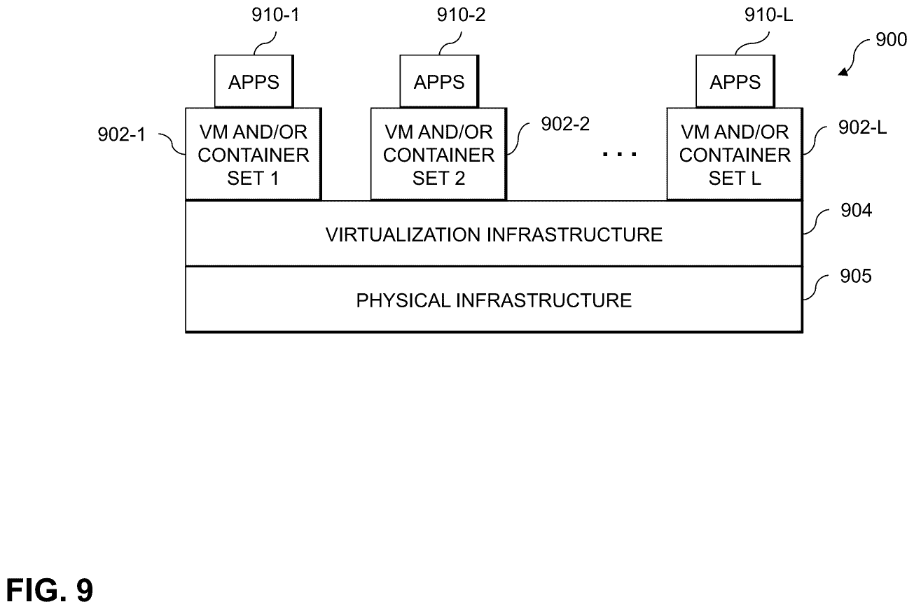

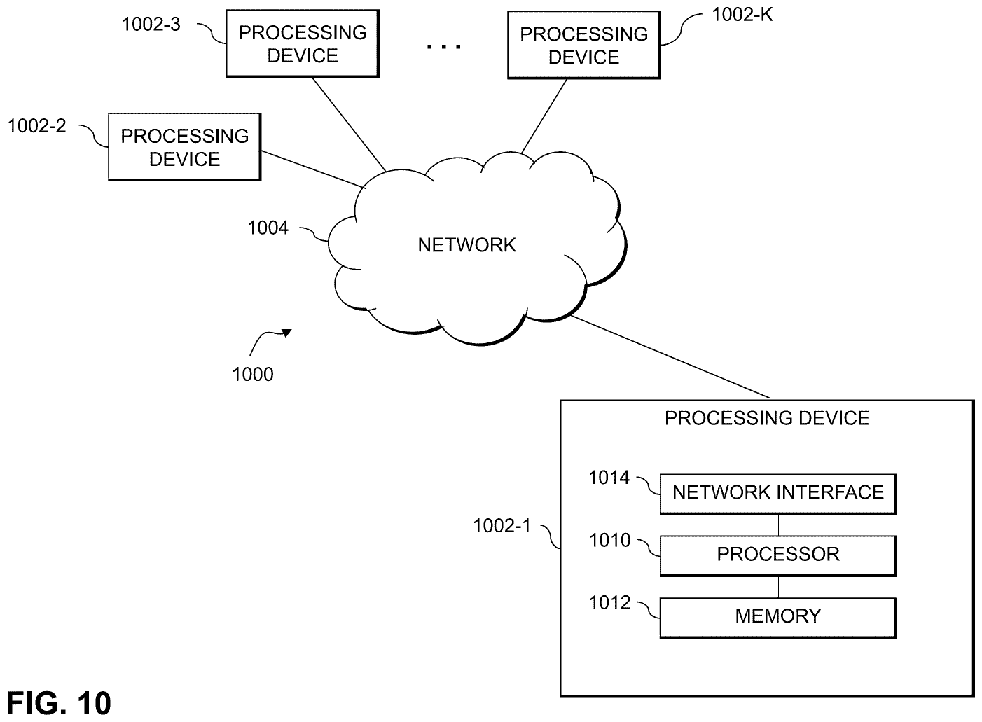

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, wherein the hypervisor platform has an associated virtual infrastructure management system. The underlying physical machines comprise one or more information processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, a CPU, a GPU, a TPU, a microcontroller, an ASIC, a FPGA or other type of processing circuitry, as well as portions or combinations of such circuitry elements.

The memory 1012 comprises RAM, ROM or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining at least one user query;
performing a comparison of the at least one user query to one or more previous user queries contained within at least portions of one or more data structures;
performing, based at least in part on results of the comparison, anomaly detection analysis on the at least one user query by processing the at least one user query against the one or more previous user queries contained within the at least portions of the one or more data structures using one or more anomaly detection algorithms; and
generating, based at least in part on results of the anomaly detection analysis, at least one response to the at least one user query by processing, using an artificial intelligence system, the at least one user query and context information related to the at least one user query;
wherein the method is performed by at least one processing device comprising a processor coupled to a memory.

2. The computer-implemented method of claim 1, wherein performing a comparison comprises:
transforming the at least one user query into at least one embedding by processing the at least one user query using at least one neural network encoder; and
using the at least one embedding to perform a semantic search of at least one vector database within the at least portions of the one or more data structures.

3. The computer-implemented method of claim 1, wherein performing a comparison comprises processing the at least one user query and the one or more previous user queries contained within the at least portions of the one or more data structures using one or more similarity search algorithms.

4. The computer-implemented method of claim 1, wherein performing anomaly detection analysis comprises processing the at least one user query against the one or more previous user queries contained within the at least portions of the one or more data structures using at least one isolation forest algorithm.

5. The computer-implemented method of claim 4, wherein processing the at least one user query against the one or more previous user queries contained within the at least portions of the one or more data structures using at least one isolation forest algorithm comprises isolating at least one non-anomalous state point, from the at least portions of the one or more data structures, using at least a first number of splits, and isolating at least one anomalous state point, from the at least portions of the one or more data structures, using at least a second number of splits.

6. The computer-implemented method of claim 1, wherein performing anomaly detection analysis comprises processing the at least one user query against the one or more previous user queries contained within the at least portions of the one or more data structures using one or more of at least one support vector machine (SVM) algorithm and at least one artificial neural network (ANN).

7. The computer-implemented method of claim 1, wherein generating at least one response to the at least one user query comprises processing the at least one user query and context information related to the at least one user query using a retrieval augmented generation (RAG) system.

8. The computer-implemented method of claim 1, wherein generating at least one response to the at least one user query comprises generating the at least one response upon a determination that (i) the at least one user query is below a designated similarity level relative to the one or more previous user queries, and (ii) the at least one user query is below a designated anomaly detection level relative to the one or more previous user queries.

9. The computer-implemented method of claim 1, wherein obtaining at least one user query comprises classifying the at least one user query based at least in part on one or more of user role and user-related domain.

10. The computer-implemented method of claim 1, further comprising:
automatically outputting the at least one response to one or more systems associated with the at least one user query.

11. A non-transitory processor-readable storage medium having stored therein program code of one or more software programs, wherein the program code when executed by at least one processing device causes the at least one processing device:
to obtain at least one user query;
to perform a comparison of the at least one user query to one or more previous user queries contained within at least portions of one or more data structures;
to perform, based at least in part on results of the comparison, anomaly detection analysis on the at least one user query by processing the at least one user query against the one or more previous user queries contained within the at least portions of the one or more data structures using one or more anomaly detection algorithms; and
to generate, based at least in part on results of the anomaly detection analysis, at least one response to the at least one user query by processing, using an artificial intelligence system, the at least one user query and context information related to the at least one user query.

12. The non-transitory processor-readable storage medium of claim 11, wherein performing a comparison comprises:
transforming the at least one user query into at least one embedding by processing the at least one user query using at least one neural network encoder; and
using the at least one embedding to perform a semantic search of at least one vector database within the at least portions of the one or more data structures.

13. The non-transitory processor-readable storage medium of claim 11, wherein performing anomaly detection analysis comprises processing the at least one user query against the one or more previous user queries contained within the at least portions of the one or more data structures using at least one isolation forest algorithm.

14. The non-transitory processor-readable storage medium of claim 11, wherein generating at least one response to the at least one user query comprises processing the at least one user query and context information related to the at least one user query using a retrieval augmented generation (RAG) system.

15. The non-transitory processor-readable storage medium of claim 11, wherein generating at least one response to the at least one user query comprises generating the at least one response upon a determination that (i) the at least one user query is below a designated similarity level relative to the one or more previous user queries, and (ii) the at least one user query is below a designated anomaly detection level relative to the one or more previous user queries.

16. An apparatus comprising:
at least one processing device comprising a processor coupled to a memory;
the at least one processing device being configured:
to obtain at least one user query;
to perform a comparison of the at least one user query to one or more previous user queries contained within at least portions of one or more data structures;
to perform, based at least in part on results of the comparison, anomaly detection analysis on the at least one user query by processing the at least one user query against the one or more previous user queries contained within the at least portions of the one or more data structures using one or more anomaly detection algorithms; and
to generate, based at least in part on results of the anomaly detection analysis, at least one response to the at least one user query by processing, using an artificial intelligence system, the at least one user query and context information related to the at least one user query.

17. The apparatus of claim 16, wherein performing a comparison comprises:
transforming the at least one user query into at least one embedding by processing the at least one user query using at least one neural network encoder; and
using the at least one embedding to perform a semantic search of at least one vector database within the at least portions of the one or more data structures.

18. The apparatus of claim 16, wherein performing anomaly detection analysis comprises processing the at least one user query against the one or more previous user queries contained within the at least portions of the one or more data structures using at least one isolation forest algorithm.

19. The apparatus of claim 16, wherein generating at least one response to the at least one user query comprises processing the at least one user query and context information related to the at least one user query using a retrieval augmented generation (RAG) system.

20. The apparatus of claim 16, wherein generating at least one response to the at least one user query comprises generating the at least one response upon a determination that (i) the at least one user query is below a designated similarity level relative to the one or more previous user queries, and (ii) the at least one user query is below a designated anomaly detection level relative to the one or more previous user queries.
